(19) United States
(12) Patent Application Publication
(10) Pub. No.: US 2011/0200838 A1
(43) Pub. Date: Aug. 18, 2011

(54) LASER CLAD METAL MATRIX COMPOSITE COMPOSITIONS AND METHODS

(75) Inventors: Ronald A. Thomas, Mosinee, WI (US); Matthew T. Calcutt, Rochester, IN (US); Jennifer L. Seefelt-Momont, Arpin, WI (US); Michael M. Priebe, Wausau, WI (US)

(73) Assignee: Clover Industries, Inc.

(21) Appl. No.: 12/964,547

(22) Filed: Dec. 9, 2010

Related U.S. Application Data
(60) Provisional application No. 61/305,852, filed on Feb. 18, 2010.

(51) Int. Cl. B32B 15/01; C22C 19/03; C22C 19/05

(52) U.S. Cl. 428/548; 420/441; 420/442

(57) ABSTRACT

A metal matrix composites is used to laser clad a surface, such as a base metal machine element, and provide high wear and corrosion resistance, particularly useful for protecting surfaces in a salt water environment. The composites may comprise up to 25 wt % Mo and up to 20 wt % WC particles in a Nickel Alloy matrix; a nickel Alloy containing 5-30% Chromium, 0-20% Molybdenum, and 0-10% Tungsten or Niobium, with the balance being Nickel.

### CROSS-REFERENCE TO RELATED PATENT APPLICATIONS

This application claims priority from Provisional Application U.S. Application 61/305,852, filed Feb. 18, 2010, incorporated herein by reference in its entirety.

### FIELD OF THE DISCLOSURE

This disclosure relates to metal matrix composites used to clad a surface and provide high wear and corrosion resistance. The technology disclosed is particularly useful for protecting surfaces in a salt water environment.

### BRIEF DESCRIPTION OF THE DRAWINGS

FIG. 1 is a series of metallographic photographs of porosity and dilution that foreshadow corrosion.

FIG. 2 is a series of photographs illustrating wet/dry corrosion results of coated rods.

FIG. 3 is a photomicrograph representative of an MMC6 flat plate sample.

### DETAILED DESCRIPTION OF THE PREFERRED EMBODIMENTS

Machines and equipment often are required to function in harsh applications where they are subject to corrosion. Specific examples include the off-shore, oil/gas equipment and many military applications that require that hydraulic cylinders with rod coatings function dependably in harsh marine environments.

Many hydraulic systems rely on hard chrome, nickel-chrome, plasma thermal spray, or High Velocity Oxygen Fuel (HVOF) thermal spray coating methods to protect components that have proven ineffective in marine conditions involving a corrosive, salt water environment.

These existing coating technologies do not meet the corrosion, wear, impact, or fatigue resistance needed for the field conditions encountered by loaded structures in a marine environment. Thermal sprays and electrolytic hard chrome coatings are porous and weakly bonded to the base material, which tend to corrode quickly in marine environments and spall under load conditions typical of a hydraulic piston rod.

For example, offshore oil drilling platforms typically employ cylinder tensioning systems, called Direct Acting Tensioners (DAT), where the piston rod is submerged in the ocean. These approximately 50 foot long cylinder rods are required to function in the most difficult combination of conditions: saltwater corrosion, temperature extremes, tensile and bending load fatigue, and constant cyclic sliding wear motion with the ocean swell. Industry experience indicates that even advanced forms of existing coating technology, such as HVOF over carbon steel or stainless steel substrates, do not meet the corrosion, wear, or fatigue resistance needed for the aggressive marine field conditions, such as those encountered by the hydraulic cylinders on a oil drilling vessel.

The technology disclosed is not limited to hydraulic cylinders in marine environments. The technology has broad application in a number of environments, including, by way of example and not by way of limitation: new hydraulic piston rods (replacing prior coating technology); repair of old chrome or thermal spray piston rods; boiler tubes & pressure vessel cladding; corrosion resistant rebars & dowels for construction & infrastructure; wear blocks for bearing surfaces on flat or round slides; marine propeller shafting; hard-facing pads on drills; and any other environment where corrosion and wear need to be minimized.

Based on industry reports, only a cost prohibitive, uncoated rod of solid Alloy 625 has been shown to provide 12+ years of field operation. Weld overlays with highly corrosion resistant Alloys (CRA), such as Alloy 625, have the potential to provide the performance of a solid CRA at a fraction of the cost. A weld overlay is a fusion process where a desirable material is metallurgically bonded to a base material to provide different properties at the surface of the base material. Hard facing for wear resistance and cladding for corrosion resistance are two common weld overlay applications.

When properly applied, Alloy 625 can provide sufficient corrosion protection, and it also has a low hardness when compared with other hard facings, and therefore, provides only limited wear resistance.

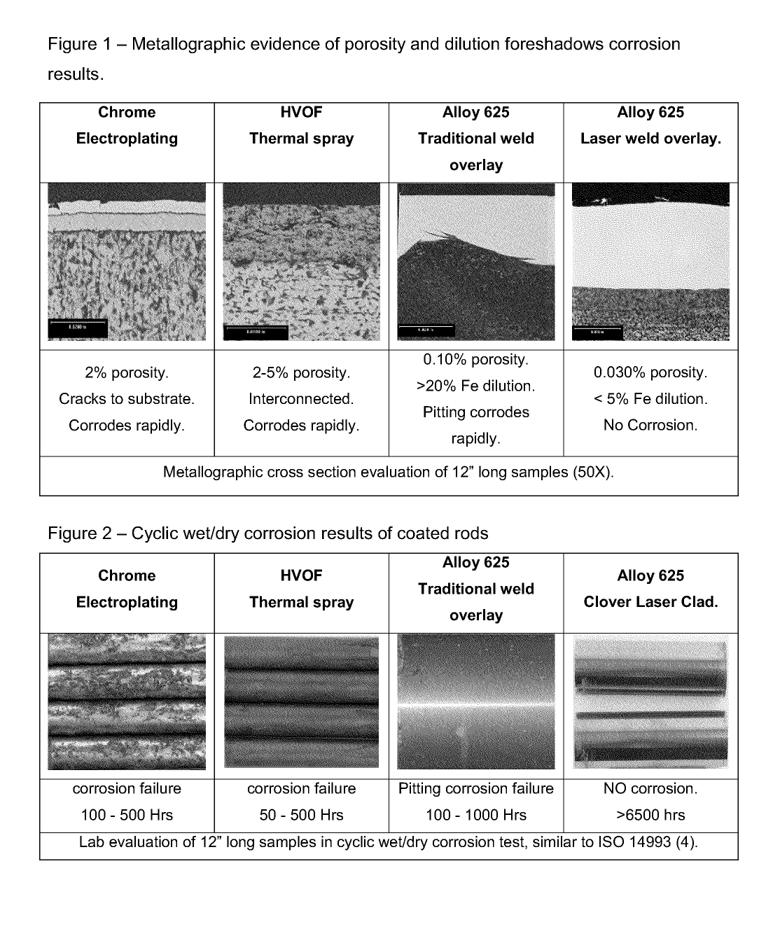

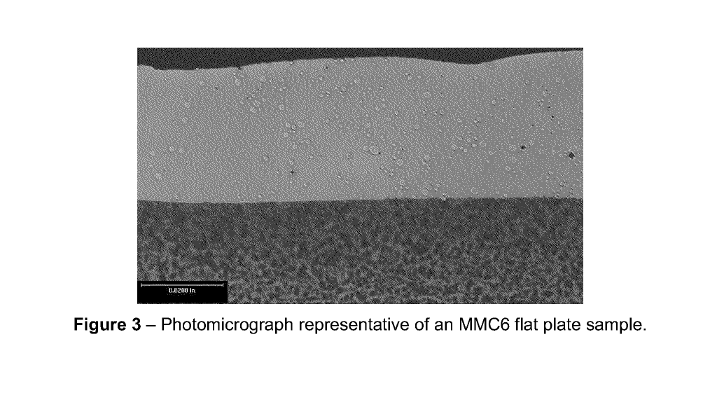

The metallographic examination in FIG. 1 indicates that the porosity and bonding of the HVOF process are inadequate for the rigors of structural cyclic load service in corrosive marine conditions. The left three pictures illustrate high porosity, cracking, and rapid corrosion resulting from chrome electroplating, thermal spray, and traditional weld overlay methods. Traditional weld overlays reveals poor process heat control, significant dilution in excess of 20%, and significant weld boundary defects. These processing defects lead to pitting corrosion in 100-1000 hrs of cyclic wet/dry saltwater testing, conducted by a protocol similar to ISO 14993 (4), as shown in the left three pictures of FIG. 2.

The disclosed precision laser technology provides improved levels of process control and more wear/corrosion resistant chemistries to provide a metallurgical bond with a nearly seamless transition from the low cost base material to a highly corrosion resistant coating, as illustrated by the right-most pictures of Tables 1 and 2. Further, laser powder deposition cladding allows for the creation of unique Alloy blends and wear particle combinations, called metal matrix composites (MMC), that are not available in solid form or by other coating processes. Laser cladding involves the use of a laser beam to provide a focused, uniform, and precise source of heat that has superior control to arc forms of heating used in other welding and weld overlay processes, such as metal-inert gas (MIG), tungsten-inert gas (TIG), and plasma transfer arc (PTA) processes.

Thermal spray processes such as plasma and HVOF may be able to provide similar powder chemistries, but cannot provide the same degree of metallurgical bonding as laser cladding. Other fusion process used in traditional weld overlay may be able to provide an adequate metallurgical bond, but cannot provide the chemistry or quality of the disclosed laser processing methods and compositions, which provide a MMC suitable for powder deposition laser cladding that testing shows to be a viable rod coating for such applications as hydraulic piston rods in demanding marine environments.

The amount of base material melted into the coating to create the metallurgical bond is called dilution. Dilution can be measured using Energy Dispersive X-ray (EDAX) analysis or can be calculated from a prepared cross section.

$$Dilution \% = \frac{Area of base material melted}{Area of base + deposit}$$

Traditional coating methods, when employing typical process parameters, yield a dilution of greater than 10%. It has generally been thought that higher dilution provides the benefits of improved metallurgical compatibility, thereby creating good welds. However, based on the present disclosure, it has been determined that, contrary to the accepted view, high levels of dilution can lead to the previously described corrosion failures, with lower levels of dilution providing superior results.

In an attempt to provide a superior rod coating, various Alloys and MMCs were evaluated. Based on experimental results, Alloy 625LCF (U.S. Pat. No. 4,765,956) was selected as a base matrix material due to commercial availability, laboratory reports, process cladability evaluations, and field reports. Other alloys may also be used, including Alloy 625 (UNS N06625), Alloy 626 (UNS N06626), Alloy 622 (UNS N06022), and Alloy 686 (UNS N06686), Alloy 59 (UNS N06059), or similar powder composition as marketed by Deloro Stellite under trade name Nistelle Super C.

A number of wear and metal particles were selected for MMC sampling in an attempt to improve the corrosion resistance and wear resistance of the base Alloy 625. Molybdenum (Mo) and Tungsten Carbide (WC) proved to be soluble and maintained even dispersions in the Alloy 625 powder. Tables 1 and 2 describe the Alloy 625, Mo, WC, and substrate steel that were used in subsequent evaluations. Such alternatives as alumina, titania, chrome oxide, and nano-scale WC were evaluated and determined not to be compatible with the physical mixing process, the fluidized Argon delivery process, or both. It should be noted that additional powder processing methods known to those skilled in the art, such as use of chemical binders, custom milling, selective sintering, agglomeration, and the like, may be deployed to correct issues of particle dispersion and accommodate a wider range of materials. For example, small wear particles might be bonded to larger carriers that ultimately disperse and melt into the surrounding matrix.

When using the process conditions described below, the Mo was found to stay as particle form in the fully fused Alloy 625 matrix with only a slight diffusion of the particle into the surrounding matrix. While not wishing to be bound by any theory, applicants believe that this controlled diffusion strengthened the nickel matrix and allowed the use of Mo loadings for corrosion resistance that have not been known to be available in any other fused coating or homogeneous chemistry, wrought, nickel Alloy. As discussed below, this resulted in improved corrosion, wear, erosion, abrasion, coefficient of friction values over previous Alloy 625 materials. The addition of WC provided further improvements to the wear resistance without reducing the corrosion resistance of the 625 Alloy matrix.

TABLE 1
Powder Data

| | | | Melt | Typical |
|---|---|---|---|---|
| Powder | | Particle Size/ | Temper- | Density |
| Name(s) | Chemistry | Morphology | ature | “as Clad” |
| Alloy 625 | Ni 21.5Cr 9Mo | −177 + 44 μm | 2350- | 0.305 lb/in³ |
| | 3.5Nb <1Fe | Spheroidal, | 2460° F. | 8.44 g/cm³ |
| | <0.5Si | Gas | 1290- | |
| | | Atomized | 1350° C. | |
| Molybdenum | Mo <1 Other | −91 + 37 μm | 4753° F. | 10.3 g/cm³ |
| (Metal | | Spheroidal, | 2623° C. | |
| Particle) | | Agglomerated | | |
| Tungsten | W 3.8C | −45 + 15 μm | 5198° F. | 15.8 g/cm³ |
| Carbide | | Spheroidal, | 2870° C. | |
| (Wear | | Fused | | |
| Particle) | | | | |

TABLE 2
Substrate Data

| Substrate | | Melt | | |
|---|---|---|---|---|
| Name | Chemistry | Temp | Hardness | Density |
| 1018 Steel | Fe .81Mn .21Si | 2640° F. | 71 RHB | 0.283 lb/in³ |
| | .21Cu .17C .08Cr | | | |

Equipment used for evaluations included a 4000 Watt (W) high powered diode laser with a 5 mm spot, a 2 mm weld overlap, and a 25 mm standoff from the work piece. The base metal substrate geometry to be coated was supported in a rotary, if round, or placed on a work table, if flat. The system utilized a powder feeder with an inert cover gas, typically 99.99% pure Argon. All %'s are on a dry weight basis. The powder was fed into a funnel-shaped nozzle that was coaxial with the laser. The laser was able to provide uniform heat to melt the fed powder, along with a small amount of the base material, which were maintained under inert gas cover.

The individual powders were weighed and physically blended in 5-10 pound batches until uniform dispersion was visually confirmed. Such batches typically required 5 to 10 minutes of blending to provide adequate dispersion. The powder mixture was then funneled into the powder feeder to the laser sampling process. The laser power, cladding speeds, powder feed rates, and preheat temperatures were varied to obtain superior porosity, dilution, and particulate dispersions.

Table 3 summarizes the chemistry of the experimental MMC mixtures. The WC particles can be classified synonymously as wear particles, while the Mo particles can be synonymously referred to as metallic particles. Tables 4-7 summarize process parameters used in evaluation of round samples and flat samples, respectively, using the materials described in Table 3. (HAZ=depth of heat effective zone and HV=Vickers hardness value.) These process conditions do not represent the entire limits by which the process could be applied by one skilled in the art. The process parameters and MMC mixtures are believed to be able to provide similar utility with other nickel alloy matrixes and with other available wear particles in either nano or micro powder sizes, provided adequate methods are used for particle dispersion, as was discussed above.

TABLE 3
MMC Experimental Mixture

| | Weight % | Weight % | Weight % |
|---|---|---|---|
| Alloy | WC Particles | Mo Particles | Alloy 625 |
| Alloy 625 | 0 | 0 | 100 |
| MMC1 | 10 | 0 | 90 |
| MMC2 | 20 | 0 | 80 |
| MMC3 | 0 | 10 | 90 |
| MMC4 | 0 | 20 | 80 |
| MMC5 | 0 | 25 | 75 |
| MMC6 | 10 | 10 | 80 |
| MMC7 | 5 | 5 | 90 |
| MMC8 | 7.5 | 7.5 | 85 |
| MMC9 | 3 | 3 | 94 |

TABLE 4
Round Samples
Round Samples on 1.5 inch OD 1018 cold finished steel bar

| | | | Porosity | | HAZ |
|---|---|---|---|---|---|
| Sample | | | (ASTM | HAZ | Hardness |
| ID | Chemistry | Dilution | E2109) | Depth | (HV) |
| — | MIG overlay | 48.0% | <1% | .087″ | 164 |
| | Alloy 625 | | | | |
| — | Comparative | 27.0% | <1% | .045″ | 282 |
| | Laser 625 | | | | |
| 1 | Alloy 625 | 2.0% | <1% | .020-.022″ | 229 |
| 2 | MMC1 | 2.6% | <1% | .030-.032″ | 202 |
| 3 | MMC2 | 1.6% | <1% | .027-.028″ | 196 |
| 4 | MMC3 | 1.5% | <1% | .027-.028″ | 208 |
| 5 | MMC4 | 2.6% | <1% | .026-.028″ | 194 |
| 6 | MMC5 | 2.5% | <1% | .026-.028″ | 216 |
| 7 | MMC6 | 2.6% | <1% | .019-.021″ | 200 |
| 8 | MMC7 | 2.3% | <1% | .019-.024″ | 233 |

TABLE 5
Rounds Sample Results

| | | | Substrate | Laser | | | |
|---|---|---|---|---|---|---|---|
| Sample | | | Hardness | Power | Preheat | Powder | Cladding |
| ID | Chemistry | Substrate | (HV) | (W) | (F.) | Feed | Velocity |
| — | MIG overlay Alloy 625 | 1.5″ 1018 Steel Bar | 166 | NA | NA | NA | NA |
| — | Comparative Laser 625 | 1.5″ 1018 Steel Bar | 232 | NA | NA | NA | NA |
| 1 | Alloy 625 | 1.5″ 1018 Steel Bar | 187 | 2720 | 265 | 40.4 g/min | 98.4 in/min |
| 2 | MMC1 | 1.5″ 1018 Steel Bar | 176 | 2640 | 325-350 | 39.0 g/min | 98.4 in/min |
| 3 | MMC2 | 1.5″ 1018 Steel Bar | 168 | 2480 | 490-510 | 42.1 g/min | 98.4 in/min |
| 4 | MMC3 | 1.5″ 1018 Steel Bar | 172 | 2560 | 290-305 | 39.0 g/min | 98.4 in/min |
| 5 | MMC4 | 1.5″ 1018 Steel Bar | 167 | 2640 | 300 | 39.3 g/min | 98.4 in/min |
| 6 | MMC5 | 1.5″ 1018 Steel Bar | 188 | 2640 | 300 | 39.0 g/min | 98.4 in/min |
| 7 | MMC6 | 1.5″ 1018 Steel Bar | 180 | 2640 | 450-475 | 40.9 g/min | 98.4 in/min |
| 8 | MMC7 | 1.5″ 1018 Steel Bar | 201 | 2680 | 350-400 | 39.3 g/min | 98.4 in/min |

TABLE 6
Flat Samples
Flat Samples on 0.725 inch thick 1018 steel

| | | | | Macro | Macro | | HAZ |
|---|---|---|---|---|---|---|---|
| Sample | | | Porosity | Hardness | Hardness | | Hardness |
| ID | Chemistry | Dilution | (ASTM E2109) | (15N) | (HV*) | HAZ Depth | (HV) |
| 9 | Alloy 625 | 3.3% | <1% | 67.9 | 225 | .026-.027″ | 239 |
| 10 | MMC1 | 2.4% | <1% | 79.8 | 384 | .017-.019″ | 227 |
| 11 | MMC2 | 2.1% | <1% | 82.9 | 446 | .022-.023″ | 235 |
| 12 | MMC3 | 2.2% | <1% | 70.0 | 247 | .022-.026″ | 231 |
| 13 | MMC4 | 1.8% | <1% | 77.7 | 346 | .021-.024″ | 222 |
| 14 | MMC6 | 2.1% | <1% | 84.2 | 475 | .026-.028″ | 214 |
| 15 | MMC7 | 2.8% | <1% | 81.1 | 415 | .031-.032″ | 241 |
| 16 | MMC8 | 2.5% | <1% | 81.0 | 402 | .031-.032″ | 245 |
| 17 | MMC9 | 3.4% | <1% | 77.0 | 327 | .023-.025″ | 225 |

*Converted from 15N

TABLE 7
Flat Sample Results

| | | | Substrate | Laser | | | |
|---|---|---|---|---|---|---|---|
| Sample | | | Hardness | Power | Preheat | Powder | Cladding |
| ID | Chemistry | Substrate | (HV) | (W) | (F.) | Feed | Velocity |
| 9 | 100% 625 | 0.725″ 1018 Steel Plate | 208 | 2720 | 270 | 38.8 g/min | 98.4 in/min |
| 10 | MMC1 | 0.725″ 1018 Steel Plate | 204 | 2560 | 700 | 38.7 g/min | 98.4 in/min |
| 11 | MMC2 | 0.725″ 1018 Steel Plate | 206 | 2640 | 420-440 | 39.1 g/min | 98.4 in/min |
| 12 | MMC3 | 0.725″ 1018 Steel Plate | 198 | 2640 | 400 | 37.8 g/min | 98.4 in/min |
| 13 | MMC4 | 0.725″ 1018 Steel Plate | 205 | 2560 | 440-450 | 38.6 g/min | 98.4 in/min |
| 14 | MMC6 | 0.725″ 1018 Steel Plate | 195 | 2440 | 620 | 38.5 g/min | 98.4 in/min |
| 15 | MMC7 | 0.725″ 1018 Steel Plate | 201 | 2840 | 350-375 | 38.6 g/min | 98.4 in/min |
| 16 | MMC8 | 0.725″ 1018 Steel Plate | 174 | 2720 | 475 | 38.4 g/min | 98.4 in/min |
| 17 | MMC9 | 0.725″ 1018 Steel Plate | 187 | 2720 | 475 | 38.2 g/min | 98.4 in/min |

Dilution rates for the samples of Tables 4 and 6 were found to be well below 5% and ranged from 1.5% to 3.4%. The addition of Mo and WC provided increasing hardness with increasing percentages of each. However, an interaction between Mo and WC was noted, where the combination of Mo and WC provided a synergistic effect of greater hardness at lower levels of loading than the hardness provided when either particle was used alone and in greater amounts.

As shown in Table 8, the disclosed process and materials yield samples with significantly better corrosion resistance when compared to competitive fusion technologies. While conventional materials failed rapidly in a ISO 14993 cyclic wet/dry saltwater corrosion test (modified to include additional heat and UV features), the tabulated materials, based on the disclosed technology, have shown no corrosion through the time periods reported. The addition of 10 wt % Mo particles yielded a significant improvement in corrosion resistance as measured by ASTM G48 temperatures. The addition of 20 wt % Mo yielded a sample that was beyond ASTM G48 test capabilities, representing a significant pitting corrosion resistance over base Alloy 625. Based on testing, the addition of 7.5% Mo provides corrosion protection beyond the capabilities of ASTM G48, which indicates the material, when applied as disclosed, will provide unparalleled, perhaps practically infinite, corrosion resistance in a marine environment.

TABLE 8
Sample Corrosion Results

| | ISO 14993 | ASTM G48 | ASTM G48 |
|---|---|---|---|
| | modified | Critical | Critical |
| | Saltwater | Pitting | Crevice |
| | Corrosion * | Temperature | Temperature |
| Chemistry | (hrs) | (° C.) | (° C.) |
| MIG overlay Alloy 625 | 500 | NA | NA |
| Comparative Laser 625 | 980 | NA | NA |
| Alloy 625 | >6528 | 65 | 35 |
| MMC 1 | >5064 | 65 | 35 |
| MMC 2 | >5064 | NA | NA |
| MMC 3 | >5064 | 80 | 65 |
| MMC 4 | >5064 | >85 | >85 |
| MMC 5 | NA | NA | NA |
| MMC 6 | >3528 | >85 | >85 |
| MMC 7 | >3528 | 75 | 60 |
| MMC 8 | NA | >85 | >85 |
| MMC 9 | NA | 75 | 60 |

* Test Completed. No corrosion present at hrs reported.

Wear testing was conducted in conformance with the ASTM G 133 (A) standard, both under dry wear and lubricated wear conditions. Dry wear test conditions were:

### Stroke=10 mm

### Normal Force=1000 gf

### Speed=100 rpm

Duration=20,000 cycles
Rider Material=aluminum oxide
Rider Radius=0.125 inch

### Temperature=Room

For lubricated wear conditions, a standard grade Mobil DTE® 24 light hydraulic oil ISO 32 was applied at the contact area using approximately 1 mL for each test. Lubricated wear test conditions were:

### Stroke=10 mm

### Normal Force=25 N

### Speed=100 rpm

Duration=20,000 cycles
Rider Material=aluminum oxide
Rider Radius=0.125 inch

### Temperature=Room

Referring to Table 9, the addition of Mo increases hardness and dry wear resistance continued to improve as Mo loading increased. The addition of WC provided additional improvements. However, the addition of 5 wt % Mo and 5 wt % WC to Alloy 625 provided performance comparable to higher loadings of either particle alone. The improved wear resistance and increased hardness of the dual particle system is combined with the added benefit of improved impact resistance, when compared to similar wear particle mixtures only. In comparison to the base Alloy 625 as tabulated in Table 10, it provided a 69% reduction in abrasive wear, an 80% reduction in sliding rider wear and an 11% reduction in lubricated sliding wear. The dry coefficient of friction (COF) also improved, demonstrating a reduction of 25%. Remarkably, the 84% increase in hardness did not reduce the impact toughness as the similar wear particle only formulations did, as shown by the bold values in Table 10.

Maximizing impact toughness against wear resistance is critical for corrosion resistance in a rugged marine environment as any small crack will ultimately lead to rapid corrosion failure. The preferred embodiment of wear, impact toughness, corrosion resistance, hardness, and COF, was found to be a mixture of 7.5% Mo and 7.5% WC. This mixture demonstrated a 69% reduction in abrasive wear, an 87% reduction in dry sliding wear, and a 47% reduction in lubricated sliding wear. The dry COF was reduced by 27% and the lubricated COF reduced by 5%. While the hardness improved 79%, the impact toughness was only reduced by 39% to an application acceptable 100 in-lbs impact toughness.

Wear testing was performed in conformance with the ASTM G174 (B) standard. The test conditions were:

Normal force mass=100 g
Spindle speed=100 rpm
Test duration=100 belt passes
Abrasive media=3 micrometer (μm) aluminum oxide microfinishing tape
Test specimen width=0.3˜2 inches
Loop speed=0.0266 m/s

Scar width was optically measured and converted to a wear volume by the geometric calculations of ASTM G77. Each scar was measured three times: edge, center, edge.

Erosion testing was performed in conformance with the ASTM G 76 standard. The impingement angle was 60 degrees and the distance between the nozzle and sample was 10 mm. The blasting pressure was 6 psi, using a 50 μm aluminum oxide test abrasive at a flow rate between 0.06 and 0.1 g/s. Each test was terminated when 20 g of abrasive hit the test specimen.

TABLE 9
Sample Wear Results

| Test Method | Alloy 625 | MMC1 | MMC2 | MMC3 | MMC4 | MMC6 | MMC7 | MMC8 | MMC9 |
|---|---|---|---|---|---|---|---|---|---|
| ASTM G133 Dry Wear (in³ × 10⁻⁸) | 9947 | 2216 | 1600 | 4339 | 2342 | 1608 | 1975 | 1286 | 1588 |
| ASTM G133 Lubricated Wear (in³ × 10⁻⁸) | 144 | 67 | 114 | 147 | 100 | 20 | 127 | 76 | 98 |
| ASTM G174 Abrasion (mm³ × 10⁻³)/m | 1.47 | 0.32 | 0.14 | 1.73 | 0.9 | 0.39 | 0.46 | 0.46 | 0.68 |
| ASTM G76 Erosion Mass Loss (mg) | 5.3 | 4.9 | 4.7 | 5.1 | 4.6 | 5.5 | 4.6 | 5.8 | 5.2 |
| ASTM G133 COF Dry | 0.59 | 0.48 | 0.49 | 0.52 | 0.48 | 0.54 | 0.44 | 0.43 | 0.47 |
| ASTM G133 COF Lubed | 0.20 | 0.20 | 0.20 | 0.18 | 0.19 | 0.21 | 0.20 | 0.19 | 0.19 |
| Impact Strength (in-lbs) | >160 | 44 | 20 | >160 | >160 | 28 | >160 | 100 | >160 |
| Hardness (HV*) | 225 | 384 | 446 | 247 | 346 | 475 | 415 | 402 | 327 |

*Converted from 15N

TABLE 10
MMC Sample Results Relative to base Alloy 625

| Alloy 625 Vs. | MMC1 | MMC2 | MMC3 | MMC4 | MMC6 | MMC7 | MMC8 | MMC9 |
|---|---|---|---|---|---|---|---|---|
| % Reduced Dry Wear | 78% | 84% | 56% | 76% | 84% | 80% | 87% | 84% |
| % Reduced Lubricated Wear | 53% | 20% | −3% | 30% | 86% | 11% | 47% | 31% |
| % Reduced Abrasion | 78% | 90% | −18% | 39% | 73% | 69% | 69% | 54% |
| % Reduced Erosion | 8% | 11% | 4% | 13% | −4% | 13% | −9% | 2% |
| % Reduced COF - Dry | 19% | 17% | 12% | 19% | 8% | 25% | 27% | 20% |
| % Reduced COF - Lubricated | 0% | 0% | 10% | 5% | −5% | 0% | 5% | 5% |
| % Increased LTC | 0% | 0% | 0% | 0% | 0% | 0% | 0% | 0% |
| % Increased CRT | 0% | 0% | 23% | 31% | 31% | 15% | 31% | 15% |
| % Increased CCT | 0% | 0% | 86% | 143% | 143% | 71% | 143% | 71% |
| % Increased Impact | −73% | −88% | 0% | 0% | −83% | 0% | −38% | 0% |
| % Increased HV | 71% | 98% | 10% | 54% | 111% | 84% | 79% | 45% |

Table 11 outlines the maximum particle concentrations allowed in an Alloy 625 matrix while maintaining a uniform, homogenous, metallurgically bonded coating free from macro cracks, micro cracks, or other dislocations and defects that would adversely affect corrosion resistance in a marine environment.

The process parameters and MMC mixtures are likely to provide similar utility with any nickel alloy matrix, cobalt alloy matrix, and with nearly any combination of available wear particles in either nano or micro powder sizes when additional fusing is provided to powder carriers to promote even dispersion.

TABLE 11
Maximum Particle Concentrations

| | Maximum Concentration |
|---|---|
| Particle | in Alloy 625 matrix |
| WC | 20% |
| Mo | 25% |
| WC + Mo | 20% |

The disclosed MMC cladding compositions allow for single-pass processing of materials because of superior properties of a thin cladding, thereby providing advantaged economics when compared to multiple pass technologies required to create thick coatings of less capable materials.

What is claimed is:

1. A composition comprising up to 25 wt % Mo and up to 20 wt % WC particles in a Nickel Alloy matrix.

2. The composition of claim 1 wherein the nickel Alloy matrix is Alloy 625 powder and wherein even dispersions of the Mo and WC particles are maintained in the Alloy 625 powder.

3. A composition comprising a MMC mixture comprising a nickel Alloy containing 5-30% Chromium, 0-20% Molybdenum, and 0-10% Tungsten or Niobium, with the balance being Nickel.

4. A machine element having a MMC powder deposition laser cladding applied to a base material.

5. The machine element of claim 4 wherein the base material is a metal.

6. The machine element of claim 4, wherein the machine element is a piston rod, and where the MMC cladding is a mixture comprising a nickel Alloy containing 5-30% Chromium, 0-20% Molybdenum, and 0-10% Tungsten or Niobium, with the balance being Nickel applied to the base material to thereby provide improved corrosion-resistance, wear, impact, or fatigue properties.

7. The machine element of claim 5 wherein the base metal dilution is less than 5%.

8. The machine element of claim 4 wherein the MMC powder deposition is applied in a single pass process.

9. The machine element of claim 4 wherein the MMC powder deposition is applied in multiple layers of a single pass process to meet any thickness required by industry.
